(19) United States
(12) Patent Application Publication
(10) Pub. No.: US 2017/0100609 A1
(43) Pub. Date: Apr. 13, 2017

(54) OCCUPANT EVACUATION CONTROL SYSTEM

(71) Applicant: OTIS ELEVATOR COMPANY, FARMINGTON, CT (US)

(72) Inventors: Arthur Hsu, South Glastonbury, CT (US); Sunil Ahuja, Milpitas, CA (US); Ritesh Khire, South Windsor, CT (US)

(73) Assignee: OTIS ELEVATOR COMPANY, FARMINGTON, CT (US)

(21) Appl. No.: 15/314,743

(22) PCT Filed: May 29, 2015
(86) PCT No.: PCT/US15/33105

§ 371 Date: Nov. 29, 2016

Related U.S. Application Data
(60) Provisional application No. 62/005,438, filed on May 30, 2014.
(60) Provisional application No. 62/004,280, filed on May 29, 2014.

(51) Int. Cl. A62B 3/00; B66B 25/00

(52) U.S. Cl. CPC A62B 3/00; B66B 25/003; G08B 7/066

(57) ABSTRACT

A method and system to direct a plurality of occupants during an evacuation of a building includes receiving at least one occupancy parameter of the plurality of occupants via at least one occupancy sensor, and controlling at least one occupancy actuator in response to the at least one occupancy parameter via an occupancy controller.

### CROSS REFERENCE TO RELATED APPLICATIONS

This patent application claims priority from U.S. Provisional Patent Application Ser. No. 62/004,280, filed May 29, 2014, and U.S. Provisional Patent Application Ser. No. 62/005,438, filed May 30, 2014, all of which are incorporated herein by reference in their entirety.

### BACKGROUND

The subject matter disclosed herein relates to building control systems, and to a system and a method for facilitating an evacuation of occupants within a building.

Typically, certain building control systems can be utilized for evacuation and threat management purposes during emergency events. For example, sprinklers, lighting systems, elevators, access control systems, etc. can be utilized to reduce risk to occupants. Advantageously, building control systems can effectively mitigate current threats and allow for evacuation of building occupants.

Evacuation and threat response plans are often include predetermined building system responses. Building control systems may provide individual control of building systems, but may not be integrated to provide a comprehensive response in accordance with dynamic threats and occupant behaviour. A system and method that can receive occupant parameters and facilitate evacuation of occupants within a building is desired.

### BRIEF SUMMARY

According to an embodiment, a method to direct a plurality of occupants during an evacuation of a building includes receiving at least one occupancy parameter of the plurality of occupants via at least one occupancy sensor, and controlling at least one occupancy actuator in response to the at least one occupancy parameter via an occupancy controller.

In addition to one or more of the features described above, or as an alternative, further embodiments could include that the at least one occupancy sensor is selected from a group consisting of: a video sensor, a LIDAR sensor, an infrared sensor, a mobile device sensor, an RFID sensor, and a manual trigger.

In addition to one or more of the features described above, or as an alternative, further embodiments could include that the at least one occupancy parameter is selected from a group consisting of: an occupant count, an occupant location, an occupant flow pattern, and an occupant mobility level

In addition to one or more of the features described above, or as an alternative, further embodiments could include that the at least one occupancy actuator is selected from a group consisting of: a display, a light output, a mobile device notification, audio announcement device, and a door access control.

In addition to one or more of the features described above, or as an alternative, further embodiments could include that the at least one occupancy actuator is selected from a group further consisting of an elevator, escalator or moving walkway control.

In addition to one or more of the features described above, or as an alternative, further embodiments could include providing the at least one occupancy parameter to at least one first responder.

In addition to one or more of the features described above, or as an alternative, further embodiments could include identifying at least one zone of the building via the occupancy controller.

In addition to one or more of the features described above, or as an alternative, further embodiments could include identifying at least one refuge zone of the at least one zone via the occupancy controller.

In addition to one or more of the features described above, or as an alternative, further embodiments could include receiving at least one threat parameter via at least one threat sensor, and controlling the at least one occupancy actuator in response to the at least one occupancy parameter and the at least one threat parameter via the occupancy controller.

In addition to one or more of the features described above, or as an alternative, further embodiments could include that the at least one threat sensor is selected from a group consisting of a threat trigger, a smoke detector, a heat detector, a hazardous chemical detector, a biological hazard detector and a detection of a weapon.

In addition to one or more of the features described above, or as an alternative, further embodiments could include that the at least one threat parameter is selected from a group consisting of: a threat type, a threat scope, a threat propagation, and a threat pattern.

In addition to one or more of the features described above, or as an alternative, further embodiments could include controlling an HVAC system in response to the at least one occupancy parameter and the at least one threat parameter via the occupancy controller.

According to an embodiment, a building control system includes at least one occupancy sensor to receive at least one occupancy parameter, an occupancy controller to control at least one occupancy actuator in response to the at least one occupancy parameter.

In addition to one or more of the features described above, or as an alternative, further embodiments could include that the at least one occupancy actuator is selected from a group consisting of: a display, a light output, a mobile device notification, an audio announcement device, and a door access control.

In addition to one or more of the features described above, or as an alternative, further embodiments could include at least one threat sensor to receive at least one threat parameter, wherein the occupancy controller controls at least one occupancy actuator in response to the at least one occupancy parameter and the at least one threat parameter.

Technical function of the embodiments described above includes controlling at least one occupancy actuator in response to the at least one occupancy parameter via an occupancy controller.

Other aspects, features, and techniques of the embodiments will become more apparent from the following description taken in conjunction with the drawings.

### BRIEF DESCRIPTION OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the FIGURES:

FIG. 1 illustrates a schematic view of an exemplary building control system for use with an embodiment; and

FIG. 2 is a flowchart illustrating a method to direct occupants during an evacuation.

### DETAILED DESCRIPTION

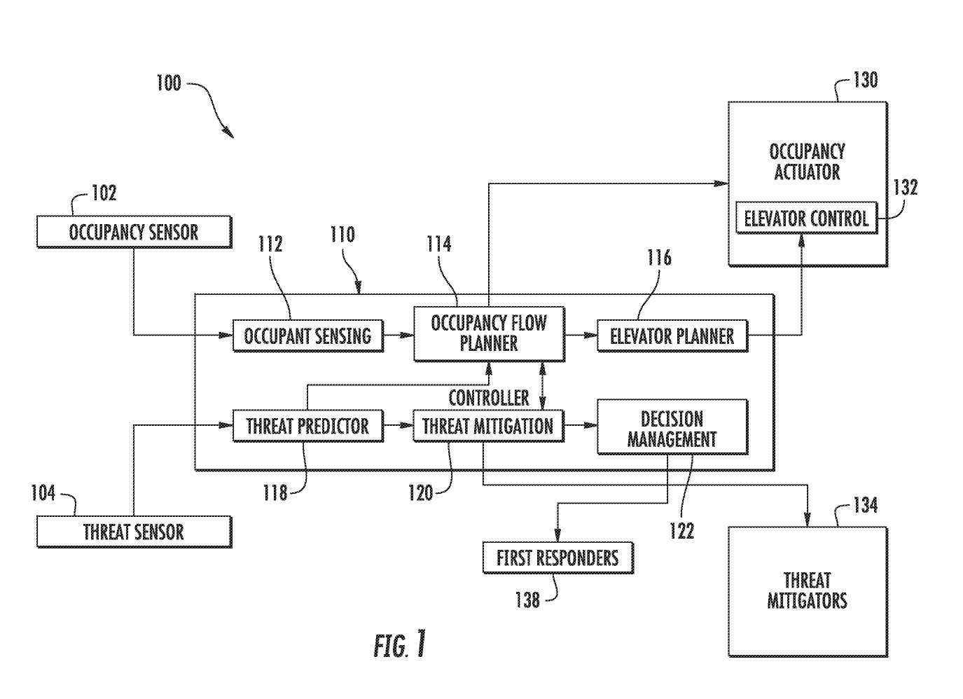

Referring to FIG. 1, an exemplary embodiment of building control system 100 is shown. In an exemplary embodiment, building control system 100 includes occupancy sensors 102, controller 110, and occupancy actuators 130. In an exemplary embodiment, building control system 100 can provide direction to occupants inside during an emergency event or other event that requires partial or full evacuation of a building. In an exemplary embodiment, system 100 provides real time decision control utilizing parameters received from occupancy sensors 102 and threat sensors 104.

In an exemplary embodiment, system 100 includes occupancy sensors 102. In certain embodiments, occupancy sensors 102 are deployable sensors mounted on mobile platforms, such as robots, that can be deployed to locations as needed. Occupancy sensors 102 can include, but are not limited to, video sensors, LIDAR sensors, infrared sensors, manual triggers/inspections, a manual counting mechanism, pyroelectric detectors, heart-beat detectors, etc. Occupancy sensors 102 can provide occupancy parameters to controller 110. Occupancy parameters can include, but are not limited to, an occupant count, an occupant location, an occupant flow pattern, an occupant mobility level, etc.

In certain embodiments, data from occupancy sensors 102 and threat sensors 104 can be combined to form data with increased accuracy. Further, in certain embodiments, occupancy sensors 102 can be defined and categorized by local zones of a building.

In an exemplary embodiment, system 100 includes threat sensors 104. In certain embodiments, threat sensors 104 are deployable sensors mounted on mobile platforms, such as robots, that can be deployed as needed. Threat sensors 104 can include, but are not limited to, a general threat trigger, a smoke detector, a heat detector, etc. Threat sensors 104 can provide occupancy parameters to controller 110. Threat parameters can include, but are not limited to, a threat type, a threat scope, a threat propagation, and a threat pattern. In certain embodiments, data from threat sensors 104 and occupancy sensors 102 can be combined to form data with increased accuracy. Further, in certain embodiments, threat sensors 104 can be defined and categorized by local zones of a building.

In an exemplary embodiment, controller 110 provides real-time control of building functions. Advantageously, controller 110 may provide emergency and threat responses based on numerous parameters, including sensed parameters and known parameters. Known parameters can include building design, such as design of stairways and corridors, location of door access control devices, number and sizing of elevators, floors served by elevators, location of occupancy sensors 102, location of threat sensors 104, etc. In an exemplary embodiment, controller 110 models emergency events and evacuation scenarios utilizing real time modeling utilizing reduced-order models. In certain embodiments, controller 110 can utilize predictive models, by first determining an objective and optimizing control strategies accordingly. In an exemplary embodiment, such strategies can be dynamically altered and updated (e.g., updating a strategy in response to a blockage of a path).

In an exemplary embodiment, controller 110 can reduce or minimize the total risk to building occupants. Further, controller 110 can further reduce risk to first responders and property. In an exemplary embodiment, controller 110 can identify portions of the building as zones to determine emergency strategies. Zones may include, but are not limited to a floor in the case of a small-footprint tall building, but could be a subset of floor in a large-footprint building; closed stairwells would comprise separate zones. Controller 110 can utilize a risk model to evaluate the risk in each zone of the building (e.g., risk is high in a zone where many heat and smoke sensors are activated) and generating a risk measure based on the number of occupants and the amount of time they spend in each zone. In certain embodiments, the risk-based strategy prioritizes egress from high-risk areas. Advantageously, the result of a risk-based strategy might be an evacuation with significantly reduced total risk.

In an exemplary embodiment, controller 110 includes an occupant sensing module 112. In an exemplary embodiment, occupant sensing module 112 can determine and interpret parameters regarding building occupants via occupancy sensors 102. In certain embodiments, occupant sensing module 112 can utilize information from threat sensors 104. Occupant sensing module 112 can determine and process occupant parameters, including, but not limited to occupant locations, occupant mobility levels, occupant flow patterns, occupant flow predictions, the number of occupants in a zone, etc. In certain embodiments, occupant sensing module 112 can provide a model of occupant locations and occupant flow predictions.

In an exemplary embodiment, occupancy flow planner 114 utilizes the output from occupant sensing module 112 to determine occupant flow strategies in response to emergency events or other events. In an exemplary embodiment, occupancy flow planner 114 determines occupant flow strategies to flow occupants out of a building or into refuge areas. Occupancy flow planner 114 can utilize people flow models that predict the flow rate in all possible egress paths, such as corridors, stairways, doorways, elevators, escalators, etc.

For example, occupancy flow planner 114 can determine optimal elevator floor selection to minimize impact on risk exposure time or other factors. In certain embodiments occupancy flow planner 114 can utilize models for human behavior under stress, such as compliance with instructions, etc. In certain embodiments, occupancy flow planner 114 can utilize models to determine exposure and duration of exposure to hazards for occupants. In certain embodiments, occupancy flow planner 114 can utilize predictive models of building equipment to predict performance of building equipment for metrics such as people moving (elevator and escalator throughput) and controlling air flow for attenuating airborne risks such as smoke and contaminants.

Advantageously, the use of real-time, predictive models allows controller 110 to determine an egress strategy that is adaptable to actual conditions rather than a fixed strategy that may have been optimized for a single condition. With predictive models, alternative strategies can be evaluated to select an optimal strategy. In certain embodiments, an advanced class of methods called predictor-corrector algorithms are employed. In certain embodiments, pathway risk measures along a number of possible pathways can be evaluated until an optimal evacuation plan is determined.

In certain embodiments, occupancy flow planner 114 directs occupants to refuge spaces instead of, or in addition to, exiting a building. A refuge space in a building may be an area with protection from spread of fire, special facilities, emergency power, etc. In certain embodiments, occupancy flow planner 114 can determine suitable refuge areas for evacuation purposes.

In an exemplary embodiment, elevator planner 116 determines optimal elevator operation in accordance with strategies created by occupancy flow planner 114. In an exemplary embodiment, elevator planner 116 can determine if elevator use is permissible, and further determine optimal combined stairway and elevator approaches.

Elevator planner 116 can evaluate operating conditions and threats relevant to elevator operation (e.g. fire, chemical, biological agents or smoke near points of elevator entry/egress) to determine if elevator assisted evacuation is possible or recommended.

In certain embodiments, elevator planner 116 can utilize load balancing methods to optimize elevator use. For example, elevator planner 116 may utilize elevators to serve a small number of floors and to have occupants not on those floors take the stairs to the served floors to optimize elevator operations. Advantageously, elevator planner 116 can balance the load on the principal bottlenecks (e.g., stairs and elevators). In certain embodiments, elevator planner 116 can utilize risk measure values to determine optimal elevator planning. Elevator planner 116 can determine risk measure value by the time (in minutes) spent at each floor in the building multiplied by the risk measure value at that floor, summed for the last evacuee from each floor to minimize such a value. In certain embodiments, elevator planner 116 can change parameters including the speed and acceleration of an elevator to prioritize throughput rather than comfort, or changing the speed and direction of an escalator or moving walkway to facilitate rapid evacuation.

In an exemplary embodiment, controller 110 includes threat predictor module 118 to utilize inputs from threat sensors 104 to determine and predict threats and threat propagation. For example, threat predictor module 118 can determine and predict the presence of smoke and predict smoke build up.

Advantageously, threat predictor module 118 can utilize a sensor fusion module to receive inputs from a plurality of sensors, such as occupancy sensors 102 and threat sensors 104 to obtain a cohesive set of parameters. Threat predictor module 118 can infer conditions based on such sensor data.

In an exemplary embodiment, threat predictor module 118 can account for the threat as it evolves over time via threat propagation model. In certain embodiments, threat prediction models allow the controller 110 to preemptively prioritize evacuating certain zones before imminent and emerging threats may put occupants in danger. These models may include combustion models in the case of fire, air flow dynamics based on temperature, stack effect, outside wind pressure, status of door opening, etc. In certain embodiments, the threat predictor model tracks and predicts the movement of an active shooter within the building.

In an exemplary embodiment, controller 110 utilizes threat mitigation module 120 to provide active mitigation to threats within the building. For example, threat mitigation module 120 can control threat mitigators 134 to reduce threats directly. In certain embodiments, threat mitigation module 120 can control threat mitigators 134 to remove smoke, close doors to control air flow, lock doors in an active shooter situation, pre-sprinkle high fire risk areas, etc.

In an exemplary embodiment, threat mitigation module 120 identifies an optimal threat mitigation plan based on the propagation assessment via the threat predictor 118. In certain embodiments, threat mitigation module utilizes building information such as available equipment and equipment capability (e.g. max pressurization achieved in a particular zone by HVAC, ability to deploy fire suppressant without contaminating adjacent zones/ducts) to determine an optimal response. In certain embodiments, threat predictor 118 can provide information to occupancy flow planner 114 to selectively direct occupants away from threats and towards desired egress points.

Threat mitigation module 120 can utilize a combination of sophisticated algorithms, heuristic rules, list of a-priori defined action plans for certain threats, etc. in response to threats. In an exemplary embodiment, threat mitigation module 120 can utilize threat mitigators 134 to deploy the selected threat mitigation plan (e.g. supply effective suppressant via sprinkler in the fire zone and pressurize the adjacent zones with HVAC).

In certain embodiments, threat mitigation module 120 can monitor the progress and effectiveness of the threat mitigation via input sensors such as occupancy sensors 102 and threat sensors 104. Further, threat mitigation module 120 may make real-time changes based on the situation.

In certain embodiments, threat mitigation module 120 can provide relevant information to the occupancy flow planner 114 to allow for evacuations to proceed accordingly.

In certain embodiments, decision management module 122 can facilitate analysis, evaluation, and execution of threat mitigation and evacuation strategies. In certain embodiments, decision management module 122 can facilitate communication with first responders that may be present or en route to the building. Decision management module 122 can further provide for
remote management of controller 110 and associated building systems by qualified personnel.

In an exemplary embodiment, the decision management module 122 provides recommendations to an operations commander or other suitable decision maker to supplement or replace autonomous deployment of evacuation and threat mitigation strategies. Advantageously, recommendations provided by decision management module 122 can be reviewed by qualified personnel. In an exemplary embodiment, any level of autonomy may be employed, as codes and practices will vary geographically and over time. Thus, embodiments may operate autonomously without human interaction or provide information for human decision making.

In certain embodiments, decision management module 122 continuously monitors sensor data to monitor the threat as it evolves (e.g., fire spreads to another floor) to determine if prioritization of evacuation should change. In certain embodiments, decision management module 122 continuously monitors egress pathways for congestion and flow, to determine if egress routing should be adjusted. In certain embodiments, as first responders request or release resources such as elevators, decision management module 122 and controller 110 can adapt to best deploy all available resources.

Advantageously, the use of decision management module 122 is not only to handle situations that evolve over time, but also to make system 100 more robust to inaccuracies in the predictive models. For example, the predictive model might not correctly account for the geometry of the stairways, which may slow down flow rates and cause congestion. Initially, the allocation strategy may be out of balance, however decision management module 122 may dynamically observe the reduced flow rate and begin re-routing occupants along a different pathway.

In certain embodiments, controller 110 can send and receive information from first responders 138 such as current occupant status and threat status. In certain embodiments, controller 110 can communicate information with first responders 138 via decision management module 122. First responders 138 can send and receive information to and from information servers that provide status information via mass notification systems, installed signage, and mobile devices. Decision management module 122 may provide access to offsite analysts (e.g., experts in a call center who can see live video feeds and assist first responders or provide additional data to the controller 110). First responders 138 can receive building control authority (e.g. elevator access) or other suitable access as required.

In an exemplary embodiment, controller 110 utilizes occupancy actuators 130 to control the flow of occupants within the building in accordance with occupancy flow planner 114. Advantageously, occupancy actuators 130 can direct occupants to desired locations such as optimal exit paths or paths to refuge zones as determined by occupancy flow planner 114.

In an exemplary embodiment, occupancy actuators 130 can include, but are not limited to a display, a light output, a mobile device notification, audio announcement device, and a door access control. In certain embodiments, occupancy actuators 130 can utilize elevator control 132 to control the flow of occupants therein.

In an exemplary embodiment, occupancy actuator 130 is dynamic signage used to guide the flow of people (e.g., turn right at this corridor intersection, go through the stairway door, etc.). In certain embodiments, occupancy actuators 130 can include supplemental status information (e.g., 12 minutes to exit) to help to allay concerns by evacuees, as well as making the signage more effective (e.g., if someone sees it will take 12 minutes using one stairway, but 17 minutes via another, they may follow the sign directing them along the best planned route).

In an exemplary embodiment, system 100 can utilize elevator control 132 as an occupancy actuator 130. Elevator control 132 can receive inputs from elevator planner 116 to determine a safe and optimal operation of elevators during emergency events.

In an exemplary embodiment, threat mitigators 134 can be controlled by threat mitigation module 120 to actively mitigate threats that may exist in the building. Threat mitigators 134 can include, but are not limited to a pre-sprinkling device, a battery discharge device, a fire suppression coating device, an inert gas release device, a controlled burn device, a robotic device, a filtration device, etc.

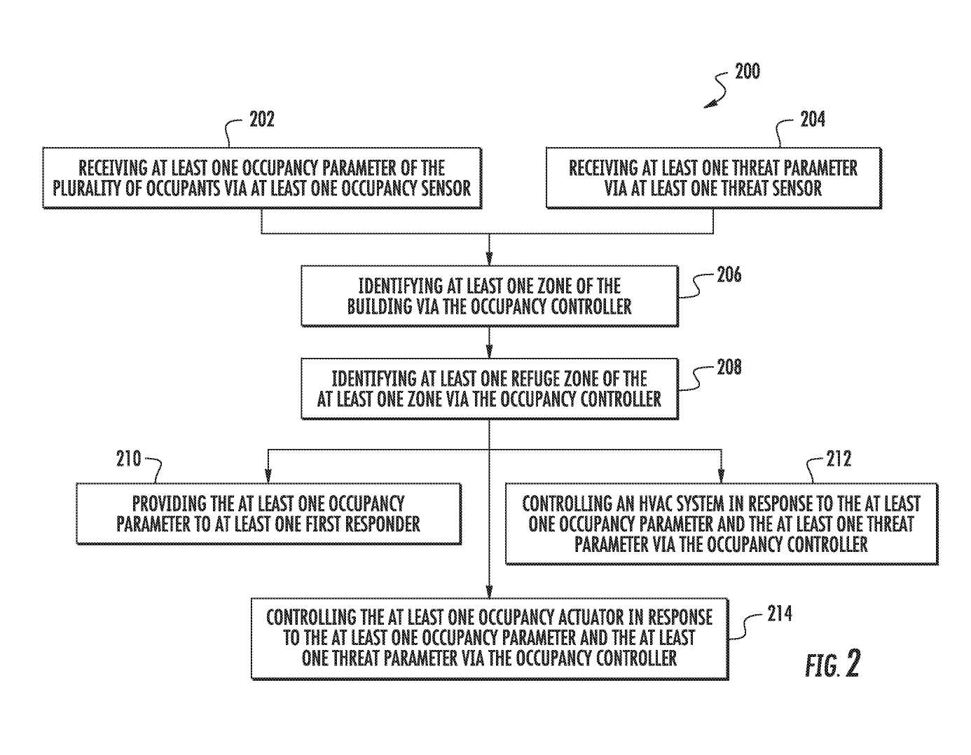

Referring to FIG. 2, a method 200 to direct a plurality of occupants during an evacuation of a building is shown. In an exemplary embodiment, method 200 can utilize system 100 described above to perform the method described herein. In operation 202, at least one occupancy sensor receives at least one occupancy parameter regarding the plurality of occupants within the building. Occupancy sensors can be any suitable occupancy sensors to determine characteristics of the occupants within. Occupancy sensors can include, but are not limited to, video sensors, LIDAR sensors, infrared sensors, manual triggers/inspections, a manual counting mechanism, pyroelectric detectors, heart-beat detectors, etc. Occupancy parameters can include, but are not limited to, an occupant count, an occupant location, an occupant flow pattern, an occupant mobility level, a building layout, etc.

In operation 204, in certain embodiments, at least one threat sensor within the building can provide at least one threat parameter. Threat sensors can include, but are not limited to, a general threat trigger, a smoke detector, a heat detector, etc. Threat parameters can include, but are not limited to, a threat type, a threat scope, a threat propagation, and a threat pattern.

In operation 206, the occupancy controller or main controller can identify zones within the building. Zones may include, but are not limited to a floor in the case of a small-footprint tall building, but could be a subset of floor in a large-footprint building; closed stairwells would comprise separate zones. The controller can utilize a risk model to evaluate the risk in each zone of the building (e.g., risk is high in a zone where many heat and smoke sensors are activated) and generating a risk measure based on the number of occupants and the amount of time they spend in each zone.

In operation 208, the occupancy controller or main controller can identify a refuge zone of the previously identified zones. In certain embodiments, refuge space in a building may be an area with protection from spread of fire, special facilities, emergency power, etc. In certain embodiments, the controller can determine suitable refuge areas for evacuation purposes.

In operation 210, controller can provide at least one occupancy parameter to at least one first responder. In certain embodiments, a controller can provide relevant information, such as occupant location, occupant flow patterns, certain occupants with injuries/limited mobility, etc.

In operation 212, a building HVAC system can be controlled by the occupancy controller or main controller in response to the occupancy parameters and any threat parameters. In certain embodiments, a building HVAC system can be used to mitigate threats such as smoke, chemicals, etc. Advantageously, HVAC systems can create zones of positive pressure to prevent smoke and chemicals in certain areas. In other embodiments, HVAC systems can be utilized to distribute fire suppression chemicals, etc.

In operation 214, at least one occupancy actuator is controlled in response to the occupancy parameters via the occupancy controller. In certain embodiments, threat parameters are also considered via the occupancy controller. In an exemplary embodiment, occupancy actuators can include, but are not limited to a display, a light output, a mobile device notification, and a door access control. In certain embodiments, occupancy actuators can utilize elevator control to control the flow of occupants therein. Advantageously, occupant flow can be controlled by the controller via the occupancy actuators to predetermined safe areas such as building exits and refuge areas in accordance with evacuation models determined by the controller.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A method to direct a plurality of occupants during an evacuation of a building, comprising:
receiving at least one occupancy parameter of the plurality of occupants via at least one occupancy sensor;
controlling at least one occupancy actuator in response to the at least one occupancy parameter via an occupancy controller; and
controlling a flow of the plurality of occupants via the at least one occupancy actuator.

2. The method of any claim 1, wherein the at least one occupancy sensor is selected from a group consisting of: a video sensor, a LIDAR sensor, an infrared sensor, a mobile device sensor, an RFID sensor, and a manual trigger.

3. The method of any of the preceding claims, wherein the at least one occupancy parameter is selected from a group consisting of: an occupant count, an occupant location, an occupant flow pattern, and an occupant mobility level.

4. The method of any of the preceding claims, wherein the at least one occupancy actuator is selected from a group consisting of: a display, a light output, a mobile device notification, an audio announcement device, and a door access control.

5. The method of claim 4, wherein the at least one occupancy actuator is selected from a group further consisting of an elevator, an escalator and a moving walkway control.

6. The method of any of the preceding claims, further comprising providing the at least one occupancy parameter to at least one first responder.

7. The method of any of the preceding claims, further comprising identifying at least one zone of the building via the occupancy controller.

8. The method of claim 7, further comprising identifying at least one refuge zone of the at least one zone via the occupancy controller.

9. The method of any of the preceding claims, further comprising:
receiving at least one threat parameter via at least one threat sensor; and
controlling the at least one occupancy actuator in response to the at least one occupancy parameter and the at least one threat parameter via the occupancy controller.

10. The method of any of claim 9, wherein the at least one threat sensor is selected from a group consisting of a threat trigger, a smoke detector, a heat detector, a hazardous chemical detector, a biological hazard detector and a detection of a weapon.

11. The method of claim 9, wherein the at least one threat parameter is selected from a group consisting of: a threat type, a threat scope, a threat propagation, and a threat pattern.

12. The method of claim 9, further comprising controlling an HVAC system in response to the at least one occupancy parameter and the at least one threat parameter via the occupancy controller.

13. A building control system, comprising:
at least one occupancy sensor to receive at least one occupancy parameter;
at least one occupancy actuator to control a flow of a plurality of occupants; and
an occupancy controller to control the at least one occupancy actuator in response to the at least one occupancy parameter.

14. The building control system of claim 12, wherein the at least one occupancy actuator is selected from a group consisting of: a display, a light output, a mobile device notification, an audio announcement device, and a door access control.

15. The building control system of any of the preceding claims, further comprising:
at least one threat sensor to receive at least one threat parameter, wherein the occupancy controller controls at least one occupancy actuator in response to the at least one occupancy parameter and the at least one threat parameter.
